(19) United States
(12) Patent Application Publication
(10) Pub. No.: US 2013/0299609 A1
(43) Pub. Date: Nov. 14, 2013

(54) Method For Improving The Dimensional Accuracy Of A Fuel Injector Component, And Fuel Injector Component

(71) Applicant: Continental Automotive GmbH, (US)

(72) Inventors: Alwin Perras, Regensburg (DE); Axel Burkhardt, Muhlhacker (DE); Christian Hagler, Nabburg (DE); Gunger Yurtseven, Regensburg (DE); Wolfgang Gerber, Wenzenbach (DE); Thomas Hofmann, Obertraubling (DE); Uwe Leuteritz, Regensburg (DE)

(21) Appl. No.: 13/853,140

(22) Filed: Mar. 29, 2013

(30) Foreign Application Priority Data
Mar. 29, 2012 (DE) 102012205044.2

(51) Int. Cl. F02M 61/18

(52) U.S. Cl. CPC F02M 61/18
USPC 239/584; 29/890.09

(57) ABSTRACT

In a final machining method for adapting a first surface of a fuel injector component to a second surface of said fuel injector component or of a second fuel injector component, or to a reference surface, e.g., for a common rail diesel injector with a register nozzle needle, the first surface and/or the second surface is deformed at least partially plastically in order to reduce a dimensional accuracy deviation which is possibly mutual. Furthermore, in a fuel injector component, e.g., a nozzle needle, nozzle needle sleeve, register nozzle needle, nozzle body, nozzle assembly and/or fuel injector, e.g., for a common rail injection system of a motor vehicle, a first surface of the fuel injector component and/or a second surface of said fuel injector component or of a second fuel injector component is deformed at least partially plastically in order to reduce a dimensional accuracy deviation.

### CROSS-REFERENCE TO RELATED APPLICATIONS

This application claims priority to DE Patent Application No. 10 2012 205 044.2 filed Mar. 29, 2012. The contents of which is incorporated herein by reference in its entirety.

### TECHNICAL FIELD

The disclosure relates to a method, e.g., a final machining method, for adapting a first surface of a fuel injector component to a second surface. Furthermore, the disclosure relates to a fuel injector component, e.g., a nozzle needle, a nozzle needle sleeve, a register nozzle needle, a nozzle body, a nozzle assembly and/or a fuel injector, e.g., for a common rail injection system of a motor vehicle.

### BACKGROUND

Statutory regulations which are becoming more and more stringent with regard to permissible pollutant emissions of internal combustion engines for motor vehicles make it necessary to achieve improved mixture preparation by means of the fuel injectors in the combustion chambers of the internal combustion engines. In the case of current fuel injectors, an injection of fuel is controlled by means of a nozzle needle which is mounted displaceably in a fuel injector and opens or closes one or a plurality of spray holes of a nozzle assembly of the fuel injector depending on its stroke. The nozzle needle is usually activated by means of a (piezo)actuator which actuates the nozzle needle hydraulically or mechanically.

For improved mixture preparation, what are known as vario or register nozzle designs are used, by way of which two spray holes or two spray hole rows of a fuel injector can be actuated sequentially. This is implemented, for example, by means of a usually hydraulic actuation of two full-fledged nozzle needles which may be arranged coaxially with respect to one another. Here, a nozzle needle is configured as a hollow needle, within which the second nozzle needle is mounted in a sliding manner. Furthermore, register nozzle designs are used, in which an outer nozzle needle sleeve surrounds the actual nozzle needle in the region of its nozzle needle tip, which nozzle needle can be mechanically actuated directly. Here, only the nozzle needle itself can be actuated directly and the nozzle needle sleeve can be actuated indirectly via the nozzle needle.

In both designs, there is the problem of dimensional accuracy of an individual component or a plurality of components and/or a relevant surface or the relevant surfaces of the component or of the components with respect to one another. This problem has an effect, e.g., in the case of a considerably advantageous, exclusively mechanical actuation of a nozzle needle, since the strokes of the nozzle needle which can be realized by means of a piezoactuator are comparatively small in comparison with a hydraulic actuation. This problem is increased in a mechanically actuable register nozzle needle with a nozzle needle sleeve, since the stroke to be realized mechanically here is divided between the nozzle needle itself and its nozzle needle sleeve which is driven by the nozzle needle for complete opening of the register nozzle needle.

### SUMMARY

One embodiment provides a method, e.g., a final machining method, for adapting a first surface of a fuel injector component to a second surface of said fuel injector component or of a second fuel injector component, or to a reference surface, e.g., for a common rail diesel injector with a register nozzle needle, wherein the first surface and/or the second surface are/is deformed at least partially plastically in order to reduce a dimensional accuracy deviation which is possibly mutual.

Another embodiment provides a fuel injector component, e.g., a nozzle needle, nozzle needle sleeve, register nozzle needle, nozzle body, nozzle assembly and/or fuel injector, e.g., for a common rail injection system of a motor vehicle, wherein a first surface of the fuel injector component and/or a second surface of said fuel injector component or of a second fuel injector component are/is deformed at least partially plastically in order to reduce a dimensional accuracy deviation.

In a further embodiment, a method or fuel injector component as disclosed above is provided, wherein the first surface, or the first and the second surface, is/are deformed or reshaped in such a way that an individual, relative or global dimensional accuracy deviation of the fuel injector component or of the fuel injector components is reduced or improved.

In a further embodiment, a method or fuel injector component as disclosed above is provided, wherein the plastic deformation or the plastically deformed section of the first surface and/or of the second surface is effected without a removal of material, and the plastic deformation or the plastically deformed section may be effected by way of embossing or an embossed section, compacting or a compacted section, pre-embossing or a pre-embossed section, pressure forming or a pressure formed section, or compression molding or a compression molded section.

In a further embodiment, a method or fuel injector component as disclosed above is provided, wherein, in the case of the fuel injector component, a contact surface which can be mechanically loaded comparatively intensively during operation of a fuel injector, e.g., a contact surface which can be mechanically loaded in a comparatively intensive and dynamic manner, is deformed plastically.

In a further embodiment, a method or fuel injector component as disclosed above is provided, wherein the first surface of an individual fuel injector component and/or the two surfaces of said fuel injector component or of two fuel injector components have/has a fluid-mechanical function for a fuel injector.

In a further embodiment, a method or fuel injector component as disclosed above is provided, wherein a dimension, an angle, a flatness, a roughness depth of the relevant surface and/or a mutual position of the two surfaces are/is set or can be set by way of the plastic deformation or by means of the plastically deformed section, the two surfaces, e.g., the two surfaces of the individual fuel injector component or of the two fuel injector components, being arranged with respect to one another, e.g., substantially in parallel, at an angle, e.g., at an acute angle or at a right angle with respect to one another.

In a further embodiment, a method or fuel injector component as disclosed above is provided, wherein a first and/or a second surface are/is a seat edge of a nozzle needle, e.g., of a nozzle needle of a register nozzle needle; a nozzle needle seat of a nozzle needle sleeve, e.g., of a nozzle needle sleeve of a register nozzle needle; a seat edge or a double seat edge of the nozzle needle sleeve and/or a nozzle needle sleeve seat or a nozzle needle sleeve double seat of a nozzle body for the fuel injector.

In a further embodiment, a method or fuel injector component as disclosed above is provided, wherein a first surface is the seat edge of the nozzle needle, and a second surface is the surface, which is complementary or corresponds thereto, of the nozzle needle seat within a nozzle needle bore of the nozzle needle sleeve, and/or a first surface is the seat edge, e.g., the double seat edge, of the nozzle needle sleeve, and a second surface is the surface, which is complementary or corresponds thereto, of the nozzle needle sleeve seat, e.g., of the nozzle needle sleeve double seat, within a nozzle bore of the nozzle body.

In a further embodiment, a method or fuel injector component as disclosed above is provided, wherein: the deformation or the deformed section of the fuel injector component is effected with retention of a global shape of the fuel injector component; the deformation or the deformed section of the fuel injector component is effected with comparatively substantial retention of the exact dimensions of the fuel injector component; the surface is deformed microscopically, mesoscopically and/or macroscopically; the deformation or the deformed section is effected by way of or by means of the nozzle needle and/or the nozzle needle sleeve, a force being exerted and/or it being possible for a force to be exerted on the nozzle needle and/or the nozzle needle sleeve; the deformation or the deformed section being effected by way of or by means of a die, an elastic recovery, e.g., of a material of the relevant fuel injector component being taken into consideration; the die being a stamp or an anvil; the fuel injector component having a plurality of fuel injector components; and/or the fuel injector component being of single-piece, one-piece, one-piece in material terms, or integral configuration, possibly in sections.

### BRIEF DESCRIPTION OF THE DRAWINGS

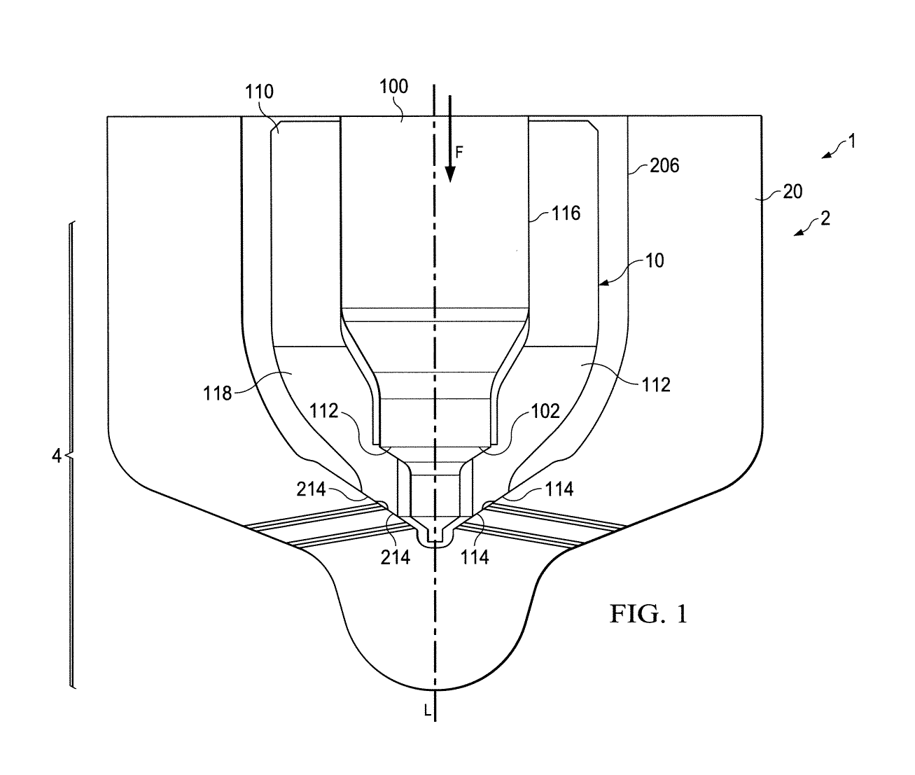

An exemplary embodiment is explained in more detail below based on FIG. 1, which shows a sectional side view of a nozzle section of an example nozzle assembly of an example fuel injector.

### DETAILED DESCRIPTION

Embodiments of the present disclosure provide a method for improving dimensional accuracy of a fuel injector component, e.g., a method for reducing a dimensional accuracy deviation of a fuel injector component or of two fuel injector components with respect to one another. Furthermore, some embodiments provide a correspondingly improved fuel injector component, e.g., a nozzle needle, a nozzle needle sleeve, a register nozzle needle, a nozzle body, a nozzle assembly and/or a fuel injector. The disclosed method may be able to be carried out inexpensively, e.g., comparatively complicated further machining of a relevant surface may be avoided.

Some embodiments provide a method, e.g., by a final machining method, for adapting a first surface of a fuel injector component to a second surface of said fuel injector component or of a second fuel injector component, or to a reference surface, e.g., for a common rail diesel injector with a register nozzle needle; and by means of a fuel injector component, e.g., a nozzle needle, a nozzle needle sleeve, a register nozzle needle, a nozzle body, a nozzle assembly and/or a fuel injector, e.g., for a common rail injection system of a motor vehicle.

In the disclosed method, e.g., a mechanical final machining method, the first surface and/or the second surface are/is deformed at least partially plastically in order to reduce a dimensional accuracy deviation of the surfaces which is possibly mutual, e.g., by way of a method or by means of an apparatus, the deformation being effected mechanically, for example. Furthermore, a first surface of the fuel injector component and/or a second surface of said fuel injector component or of a second fuel injector component are/is deformed at least partially plastically in order to reduce a dimensional accuracy deviation, the deformation once again being effected mechanically, for example.

Here, a reference face for the plastic deformation or reshaping or pressure forming, that is to say a method without chipping or cutting, can be the second surface or a reference face. This applies analogously to a reference point. Here, it is of course possible to interchange the second with the first surface. Furthermore, in the following text, a surface, e.g., the second surface, can also be understood to be the reference surface which can lie outside the relevant component, for example on a machine tool.

In some embodiments, the first surface, or the first and the second surface, is/are deformed or reshaped in such a way that an individual, relative or global dimensional accuracy deviation of the fuel injector component or of the fuel injector components is reduced or improved. The plastic deformation or the plastically deformed section of the first surface and/or of the second surface is effected without a removal of material, the plastic deformation or the plastically deformed section may be effected by way of embossing or an embossed section, compacting or a compacted section, pre-embossing or a pre-embossed section, pressure forming or a pressure formed section, or compression molding or a compression molded section.

In the case of the fuel injector component, a contact surface which can be mechanically loaded comparatively intensively during operation of a fuel injector, e.g., a contact surface which can be mechanically loaded in a comparatively intensive and dynamic manner, is deformed plastically. Thus, for example, the first surface of an individual fuel injector component and/or the two surfaces of said fuel injector component or of two fuel injector components can have a fluid-mechanical function for a fuel injector.

A dimension, an angle, a flatness, a roughness depth of the relevant surface and/or a mutual position of the two surfaces are/is set or can be set by way of the plastic deformation or by means of the plastically deformed section. Here, the two surfaces, e.g., the two surfaces of the individual fuel injector component or of the two fuel injector components, can be arranged with respect to one another, e.g., substantially in parallel, at an angle, e.g., at an acute angle or at a right angle with respect to one another.

In some embodiments, a first and/or a second surface can be a seat edge of a nozzle needle, e.g., of a nozzle needle of a register nozzle needle; a nozzle needle seat of a nozzle needle sleeve, e.g., of a nozzle needle sleeve of a register nozzle needle; a seat edge or a double seat edge of the nozzle needle sleeve and/or a nozzle needle sleeve seat or a nozzle needle sleeve double seat of a nozzle body for the fuel injector.

In some embodiments, a first surface is the seat edge of the nozzle needle, and a second surface is the surface, which is complementary or corresponds thereto, of the nozzle needle seat within a nozzle needle bore of the nozzle needle sleeve. Furthermore, in some embodiments, a first surface is the seat edge, e.g., the double seat edge, of the nozzle needle sleeve, and a second surface is the surface, which is complementary or corresponds thereto, of the nozzle needle sleeve seat, e.g., of the nozzle needle sleeve double seat, within a nozzle bore of the nozzle body.

In some embodiments, the deformation or the deformed section of the fuel injector component can be effected with retention of a global shape of the relevant fuel injector component. Furthermore, the deformation or the deformed section of the fuel injector component can be effected with comparatively substantial retention of the exact dimensions of the fuel injector component. Here, the comparatively thin surface is deformed microscopically, mesoscopically and/or macroscopically.

The deformation or the deformed section may be effected by way of or by means of the nozzle needle and/or the nozzle needle sleeve, a force being exerted and/or it being possible for a force to be exerted on the nozzle needle and/or the nozzle needle sleeve. Furthermore, the deformation or the deformed section can be effected by way of or by means of a die, an elastic recovery, e.g., with consideration of a relevant thickness, of a material of the relevant fuel injector component being taken into consideration, for example. The die can be, for example, a stamp or an anvil. Furthermore, the fuel injector component can have a plurality of fuel injector components, and can consequently be configured in two pieces or more. Moreover, the fuel injector component can be of single-piece, one-piece, one-piece in material terms, or integral configuration, possibly in sections.

In some embodiments, a method is specified for improving a dimensional accuracy, e.g., a method for reducing a dimensional accuracy deviation, of a fuel injector component or of two fuel injector components with respect to one another, and a correspondingly improved fuel injector component. Here, the disclosed method can be carried out inexpensively, since a method is applied which is distinguished not by a removal of material, but rather by reshaping of the relevant surface of the fuel injector component, which reshaping is plastic, that is to say permanently durable, and possibly merely partial. Comparatively complicated further machining of the relevant surface can therefore be dispensed with.

As a result of the embossing or pre-embossing of at least one fuel injector component, adaptation or leveling of the relevant surface of the component or of the relevant surfaces of the components of the fuel injector is achieved. Furthermore, if the disclosed concepts are applied to a nozzle section of a fuel injector, a robustness with respect to wear of a nozzle needle seat is improved. In the case of register nozzle needles, a reduction of tolerances in a securing plate or a driving clip is possible, which in turn reduces stroke losses. Furthermore, sorted pairing of fuel injector components for a single defined fuel injector can be dispensed with.

With reference to FIG. 1, an example embodiment is now explained in greater detail using a fuel injector 1 with a register or vario arrangement of a nozzle section 4 of the fuel injector 1. That is to say, the nozzle section 4 of a nozzle assembly 2 of the fuel injector 1 has a register or vario nozzle needle 10 (fuel injector component 10) which is configured in two pieces, the two components 100, 110 of the register nozzle needle 10 being arranged coaxially with respect to one another. In the present case, the register nozzle needle 10 comprises an actual nozzle needle 100 (fuel injector component 100) and a nozzle needle sleeve 110 (fuel injector component 110). Of course, two full-fledged nozzle needles or only a single nozzle needle can also be used (both not shown in FIG. 1).

The fuel injector 1 may be configured as a diesel injector 1. However, embodiments are not restricted to diesel injectors 1, but can also be applied to other fuel injectors, such as gasoline injectors. Furthermore, the expression “surface” here is not to be understood to be a two-dimensional structure such as a (flat) side or a (mathematical) area, but rather a comparatively thin, three-dimensional layer, it being possible for a thickness of the layer to be a multiple of a roughness depth of a relevant fuel injector component 10; 100, 110; 20 up to approximately one millimeter.

The register nozzle needle 10 or the fuel injector component 10 comprises the two fuel injector components 100, 110 which can be moved substantially linearly with respect to one another and are prestressed mechanically with respect to one another (not shown in FIG. 1) by means of an energy store element which may be configured as a spring element or a compression spring. Here, the first component 100 of the register nozzle needle 10 may be the actual nozzle needle 100 which can be actuated by an actuator (not shown in FIG. 1), and the second component 110 of the register nozzle needle 10 may be the nozzle needle sleeve 110 which can also be called a register sleeve 110 or vario sleeve 110.

The nozzle needle sleeve 110 surrounds the nozzle needle 100 on its nozzle-side (4) longitudinal end section preferably completely in the circumferential direction and, in a longitudinal direction L of the nozzle needle 100, extends a little in the direction of a drive-side longitudinal end of the nozzle needle 100. Aside from a cone of the nozzle needle 100, the nozzle needle sleeve 110 is seated in a slidingly mounted manner on a cylindrical longitudinal section of the nozzle needle 100.

A fluid channel is provided between the cone of the nozzle needle 100 and the nozzle needle sleeve 100 which surrounds said cone, through which fluid channel fuel can flow to the cone of the nozzle needle 100. Here, the fuel passes from the outside via one or a plurality of bores 118 or through bores 118 in the nozzle needle sleeve 120 to the fluid channel. Furthermore, fuel can flow on the outside along the nozzle needle sleeve 110 to a sealing seat 114, 214 of the register nozzle needle 10, e.g., a sealing seat 114, 214 of the nozzle needle sleeve 110 with the nozzle body 20. In this region, the nozzle needle sleeve 110 is likewise of conical configuration.

A first sealing seat 102, 112 of the nozzle assembly 4 is provided between an annular section of a free longitudinal end section of the nozzle needle 100 and an inner region of the nozzle needle sleeve 110, which inner region corresponds to said annular section or is of complementary configuration with respect thereto, which first sealing seat 102, 112 is set or not depending on a position of the nozzle needle 100 with respect to the nozzle needle sleeve 110. In a closed position (see FIG. 1) of the nozzle needle 100 with respect to the nozzle needle sleeve 110, the first sealing seat 102, 112 is set, a seat edge 102 of the nozzle needle 100 being seated on a nozzle needle seat 112 of the nozzle needle sleeve 110, said nozzle needle seat 112 being provided inside a nozzle needle bore 116 of the nozzle needle sleeve 110.

The closed position of the nozzle needle 100 on/in the nozzle needle sleeve 110 shuts a fluid throughflow between the nozzle needle 100 and the nozzle needle sleeve 100 to a first spray hole 201 or to a first spray hole row 201. In an open position (not shown in FIG. 1), the nozzle needle 100 is lifted up from the nozzle needle sleeve 110, the first sealing seat 102, 112 is no longer set and fuel can be injected through the first spray hole row 201.

A second sealing seat 114, 214 of the nozzle assembly 4 is provided between two radially offset, annular sections of a tip section of the nozzle needle sleeve 110 and inner regions of the nozzle body 20 which correspond thereto or are of complementary configuration with respect thereto, which second sealing seat 114, 214 can be set depending on a position of the nozzle needle sleeve 110 with respect to the nozzle body 20. Here, the first sealing seat 102, 112 can be set (see closed position in FIG. 1) or not (not shown in FIG. 1).

The second sealing seat 114, 214 is set in a closed position of the nozzle needle sleeve 110 with respect to the nozzle body 20, a seat edge 114 or a double seat edge 114 of the nozzle needle sleeve 110 being seated on a nozzle needle sleeve seat 214 or a nozzle needle sleeve double seat 214 of the nozzle body 20. The second sealing seat 114, 214 is not set in an open position of the nozzle needle sleeve 110 with respect to the nozzle body 20.

In the closed position of the nozzle needle sleeve 110 on/in the nozzle body 20, the second sealing seat 114, 214 shuts off the fluid throughflow between the nozzle body 20 and the nozzle needle sleeve 120 and the fluid throughflow between the nozzle needle 100 and the nozzle needle sleeve 110 to a second spray hole 202 or to a second spray hole row 202. In order to obtain defined sealing seats in the second sealing seat 114, 214, a, preferably completely circumferential, recess which is arranged in the region of the second spray hole row 202 in the closed position can be provided in the region of the second spray hole row 202 on the outside in the nozzle needle row 110.

In FIG. 1, both spray hole rows 201, 202 of the nozzle body 20 are closed; the first 102, 112 and the second sealing seat 114, 214 seal. If, during opening, the nozzle needle 100 has moved away from the nozzle needle row 110 only such that the second sealing seat 114, 214 remains set (no stroke of the nozzle needle sleeve 120, since the energy store element presses the nozzle needle sleeve 120 into the nozzle needle sleeve seat 214 (not shown in FIG. 1)), the first sealing seat 102, 112 is open, and fuel can be injected through the lower spray hole row 201.

During further opening of the register nozzle needle 10 (here, the nozzle needle 100 drives the nozzle needle sleeve 120, see following text), both spray hole rows 201, 201 of the nozzle body 20 are open, sealing seat is no longer set and the register nozzle needle 10 or the nozzle needle sleeve 120 has moved away from its second sealing seat 114, 214, the nozzle needle 100 may likewise be spaced apart from the nozzle needle sleeve 110. Closing of the register nozzle needle 10 takes place in a reverse sequence.

During opening of the register nozzle needle 10, the nozzle needle 100 drives the nozzle needle sleeve 110. For this purpose, the nozzle needle 100 and/or the nozzle needle sleeve 110 have/has corresponding devices or mechanical driving devices which, in the case of a compressed energy store element between the nozzle needle 100 and the nozzle needle sleeve 110, drive the nozzle needle sleeve 120 with the nozzle needle 100 only after bridging of the mechanical play.

Possible driving concepts are, for example: a securing piece or plate which may be configured as a C-shaped securing ring; driving of the nozzle needle sleeve 110 by means of the nozzle needle 100 via a stop ring which is welded to the nozzle needle sleeve 110; a preferably radially elastic driving ring which can be provided, for example, as a circlip on the nozzle needle sleeve 110; one or a plurality of radial pins which couple the nozzle needle 100 and the nozzle needle sleeve 110 in a manner which is affected by play, etc.

In particular in the case of the faces which form the sealing seats 102, 112; 114, 214, that is to say the face of the seat edge 102, of the nozzle needle seat 112 (first sealing seat 102, 112), of the seat edge 114 and of the nozzle needle sleeve seat 214 (second sealing seat 114, 214), dimensional accuracy deviations of the respective fuel injector component 10, 100, 110; 20; . . . , that is to say deviations from a predefined ideal dimension, have comparatively pronounced effects on the injection quantities of the relevant fuel injector 1. In order to reduce or compensate for said dimensional accuracy deviations, embossing, compacting, pre-embossing, pressure forming or compression molding of one or a plurality of the relevant surfaces takes place in such a way that said surface or surfaces is/are deformed at least partially plastically in order to reduce the dimensional accuracy deviation which is possibly mutual.

In some embodiments a mechanical machining or final machining method takes place for the relative and/or final adaptation of a first surface of a fuel injector component 10; 100, 110; 20; . . . to a second surface or a reference surface of said fuel injector component 10; 100, 110; 20; . . . or of a second fuel injector component 10; 100, 110; 20; . . . , the first surface and/or the second surface being deformed at least partially plastically. Here, a mechanical (final) machining method is to be understood to mean a method, the focus of which lies on the plastic deformation of the relevant surface and not, for example, in refining of the surface.

In some embodiments, merely the surfaces are oriented, but there is no removal or addition of material. Mechanical reshaping takes place with retention of the substantially comparatively exact shape, that is to say in other words that a cube remains a cube and a sphere remains a sphere with virtually identical dimensions; this applies analogously to other shapes or sections thereof. Here, this is an elimination, a compensation, a reduction or a minimization of a tolerance of the relevant fuel injector component 10; 100, 110; 20; . . . . The pre-embossing of the fuel injector components 10; 100, 110; 20; . . . , that is to say, e.g., of the nozzle needle 100, of the nozzle needle sleeve 110 and the nozzle body 20, takes place by the introduction of a force F to the corresponding surface.

This can take place by means of a die (not shown in the drawing) or by means of the register nozzle needle 10, the nozzle needle 100 and/or the nozzle needle sleeve 110. This may take place via the introduction of a force F merely to the nozzle needle 100, since, as a result, all the involved faces of the sealing seats 102, 112; 114, 214 are likewise loaded with a force. Depending on a size of the involved faces, this correspondingly results in a more or less intense surface pressure. In some embodiments, the relevant faces, e.g., the relevant contact faces in the nozzle section 4, are leveled on the corresponding fuel injector components 10; 100, 110; 20; . . . , and the stroke loss and wear of the corresponding fuel injector components 10; 100, 110; 20 are minimized there.

What is claimed is:

1. A machining method for adapting a first surface of a fuel injector component to a second surface comprising one of (a) another surface of said fuel injector component, (b) a surface of a second fuel injector component, or (c) a reference surface, the method comprising:
deforming at least one of the first surface and the second surface at least partially plastically in order to reduce a dimensional accuracy deviation of the at least one of the first and second surfaces from at least one predetermined dimension.

2. The method of claim 1, comprising deforming or reshaping the at least one of the first and second surface in such a way that a dimensional accuracy deviation of the fuel injector component or of the fuel injector component is reduced.

3. The method of claim 1, wherein the plastic deformation of the at least one of the first and second surface is effected without a removal of material, and wherein the plastic deformation is effected by at least one of embossing, compacting, pre-embossing, pressure forming, or compression molding.

4. The method of claim 1, wherein the first surface of the fuel injector component comprises a contact surface configured for mechanical and dynamic loading during operation of a fuel injector.

5. The method of claim 1, wherein the first surface of the fuel injector component provides a fluid-mechanical function for a fuel injector.

6. The method of claim 1,
wherein at least one of a dimension, an angle, a flatness, a roughness depth of the first or second surface, and a mutual position of the first and second surfaces is set or settable by the plastic deformation, and
wherein the first and second surfaces are arranged in parallel, at an acture angle, or at a right angle with respect to one another.

7. The method of claim 1, wherein at least one of the first and second surfaces forms a seat edge of a nozzle needle, a nozzle needle seat of a nozzle needle sleeve, a seat edge or a double seat edge of a nozzle needle sleeve, or a nozzle needle sleeve seat or a nozzle needle sleeve double seat of a nozzle body.

8. The method of claim 1, wherein the first surface forms a seat edge of the nozzle needle, and the second surface forms a surface complementary or corresponding to the seat edge.

9. The method of claim 1, comprising at least one of the following:
the deformation of the at least one of the first and second surface being effected with retention of a global shape of the fuel injector component;
the deformation of the at least one of the first and second surface being effected with comparatively substantial retention of the exact dimensions of the fuel injector component;
the at least one of the first and second surface being deformed at least one of microscopically, mesoscopically, and macroscopically;
the deformation of the at least one of the first and second surface being effected by a force exerted on at least one of a nozzle needle and a nozzle needle sleeve;
the deformation of the at least one of the first and second surface being effected by way of or by means of a die, wherein an elastic recovery of a material of the relevant fuel injector component is taken into consideration;
the die being a stamp or an anvil;
the fuel injector component having a plurality of fuel injector components; and
the fuel injector component being of a single-piece, a one-piece, or an integral configuration.

10. A fuel injector component for a common rail injection system of a motor vehicle, wherein at least one of a first surface and a second surface of the fuel injector component is deformed at least partially plastically to reduce a dimensional accuracy deviation from a predetermined dimension.

11. The fuel injector component of claim 10, wherein the plastic deformation is effected without a removal of material, and wherein the plastic deformation is effected by at least one of embossing, compacting, pre-embossing, pressure forming, or compression molding.

12. The fuel injector component of claim 10, wherein the first surface of the fuel injector component comprises a contact surface configured for mechanical and dynamic loading during operation of a fuel injector.

13. The fuel injector component of claim 10, wherein the first surface of the fuel injector component is configured to provide a fluid-mechanical function for a fuel injector.

14. The fuel injector component of claim 10, wherein the first and second surfaces are arranged in parallel, at an acture angle, or at a right angle with respect to one another.

15. The fuel injector component of claim 10, wherein at least one of the first and second surfaces forms a seat edge of a nozzle needle, a nozzle needle seat of a nozzle needle sleeve, a seat edge or a double seat edge of a nozzle needle sleeve, or a nozzle needle sleeve seat or a nozzle needle sleeve double seat of a nozzle body.

16. The fuel injector component of claim 11, wherein the first surface forms a seat edge of the nozzle needle, and the second surface forms a surface complementary or corresponding to the seat edge.

17. The fuel injector component of claim 10, wherein the deformation of the at least one of the first and second surface is effected by a force exerted on at least one of a nozzle needle and a nozzle needle sleeve.
